(19) United States
(12) Patent Application Publication
(10) Pub. No.: US 2015/0202751 A1
(43) Pub. Date: Jul. 23, 2015

(54) TOOL BIT ADAPTER

(71) Applicant: GOOD YEAR HARDWARE CO., LTD., Changhua (TW)

(72) Inventor: Tsai-Ching CHEN, Changhua (TW)

(73) Assignee: GOOD YEAR HARDWARE CO., LTD., Changhua (TW)

(21) Appl. No.: 14/256,802

(22) Filed: Apr. 18, 2014

(30) Foreign Application Priority Data
Jan. 22, 2014 (TW) 103102344
Mar. 7, 2014 (TW) 103107951

(51) Int. Cl. B25B 23/00; B23B 31/10

(52) U.S. Cl. CPC B25B 23/0035; B23B 31/10; B23B 2260/10; B23B 2231/00

(57) ABSTRACT

A tool bit adapter includes a base member including a cylindrical body having a receiving open chamber formed of a front small diameter portion, a rear large diameter portion and one or multiple through holes in communication between the small diameter portion and the atmosphere, a ball mounted in each through hole, an operating member slidably sleeved onto the cylindrical body and having an inside groove and a pressure face, a pusher accommodated in the cylindrical body and having one or multiple recessed retaining portions. When the pusher is in the rear end position, the pressure face of the operating member forces the balls toward the inside of the receiving open chamber into engagement with the respective recessed retaining portions. Thus, the tool bit adapter can positively detachably secure the loaded tool bit without any additional positioning structure.

### BACKGROUND OF THE INVENTION

1. Field of the Invention

The present invention relates to hand tool technology and more particularly, to a tool bit adapter for hand tool.

2. Description of the Related Art

U.S. Pat. No. 6,637,755 discloses a chuck device for miniature tool bits, which includes a sleeve (20), a socket (10), a ball (14) received in between the sleeve (20) and each hole in the socket (10), and a pusher (30) mounted in the socket to stop against the balls. When installing a tool bit in the chuck device, insert the tool bit into the socket to push the pusher away from the balls. At this time, the sleeve can push the balls in direction toward the inside of the socket, forcing the balls into engagement with respective recesses in the miniature tool bit.

The aforesaid chuck device secures the inserted miniature tool bit by means of forcing the balls into engagement with respective recesses in the miniature tool bit. Due to that the tool bit must have recesses for receiving the balls, and the recesses of the tool bit must be defined corresponding to the locations of the balls, any miniature tool bit applicable to the chuck device must meet the above-described restrictions.

### SUMMARY OF THE INVENTION

The present invention has been accomplished under the circumstances in view. It is the main object of the present invention to provide a tool hit adapter, which can positively detachably secure the loaded tool bit without any additional positioning structure.

To achieve this and other objects of the present invention, a tool bit adapter of the invention comprises a base member, which comprises a cylindrical body that comprises a receiving open chamber defined therein, an orifice located in a front end thereof in communication with the receiving open chamber, an internal small diameter portion formed of a front part of the receiving open chamber for receiving a tool bit that is inserted through the orifice, an internal large diameter portion formed of a rear part of the receiving open chamber, an internal shoulder connected between the small diameter portion and the large diameter portion, at least one through hole cut through the cylindrical body in communication between the small diameter portion and the atmosphere, a first annular groove extending around the periphery of the cylindrical body near a rear end thereof, at least one ball respectively accommodated in the at least one through hole, and a retaining ring mounted in the first annular groove of the cylindrical body, an operating member, which comprises an inside groove made in an annular shape and extending around an inside wall thereof, a pressure face made in an annular shape and extending around the inside wall thereof, a first elastic member mounted around the periphery thereof and stopped between the retaining ring and the operating member to impart an elastic force to the operating member in a predetermined direction, and a locating ring mounted in a rear end thereof, a pusher, which is received in the receiving open chamber of the cylindrical body and slidable relative to the cylindrical body between a front end position and a rear end position, comprising at least one recessed retaining portion located in the periphery thereof, a second annular groove extending around the periphery near a rear end thereof, a second retaining ring fastened to the second annular groove and stopped against the shoulder of the cylindrical body, and a second elastic member stopped between the pusher and a bottom wall of the receiving open chamber of the cylindrical body to impart an elastic force to the pusher, and a locating member for detachably securing an inserted tool bit in the small diameter portion of the receiving open chamber. When the pusher is in the rear end position, the at least one ball is forced by the pressure face of the operating member toward the inside of the receiving open chamber into engagement with the at least one recessed retaining portion. Thus, the tool bit adapter can positively detachably secure the loaded tool bit without any additional positioning structure.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an elevational view of a tool bit adapter in accordance with a first embodiment of the present invention.

FIG. 2 is an exploded view of the tool bit adapter in accordance with a first embodiment of the present invention.

FIG. 3 illustrates the relationship between the needle rollers and the elongated through holes in the cylindrical body in accordance with the first embodiment of the present invention.

FIG. 4 is a sectional view taken along line 4-4 of FIG. 1, illustrating the status of the tool bit adapter before loading of a tool bit.

FIG. 5 is a schematic sectional view of the first embodiment of the present invention, illustrating a tool bit inserted into the base member.

FIG. 6 corresponds to FIG. 5, illustrating the tool bit secured in position in the tool bit adapter.

FIG. 7 is a sectional view taken along line 7-7 of FIG. 6, illustrating the balls engaged in the retaining grooves of the pusher.

FIG. 8 is a schematic sectional view of the first embodiment of the present invention, illustrating the pusher pushed, the tool bit extended out of the cylindrical body.

FIG. 9 is a schematic sectional view of a tool bit adapter in accordance with a second embodiment of the present invention before loading of a tool bit.

FIG. 10 corresponds to FIG. 9, illustrating a tool bit installed in the tool bit adapter.

FIG. 11 is a front view of a screw with a slot on the head thereof in accordance with the second embodiment of the present invention.

FIG. 12 is a schematic drawing of the second embodiment of the present invention, illustrating the magnetic ring attached to the head of a screw.

FIG. 13 corresponds to FIG. 12, illustrating the driving tip of the tool bit engaged into the slot in the head of the screw.

FIG. 14 is a schematic drawing of the second embodiment of the present invention, illustrating the pusher pushed, the tool bit extended out of the base member.

FIG. 15 is a schematic sectional view of a tool bit adapter in accordance with a third embodiment of the present invention after loading of a tool bit.

FIG. 16 corresponds to FIG. 15, illustrating the tool bit detached from the tool bit adapter.

FIG. 17 is a schematic sectional view of a tool bit adapter in accordance with a fourth embodiment of the present invention after loading of a tool bit.

FIG. 18 is a perspective view of the cylindrical body and pusher of the tool hit adapter in accordance with the fourth embodiment of the present invention.

### DETAILED DESCRIPTION OF THE INVENTION

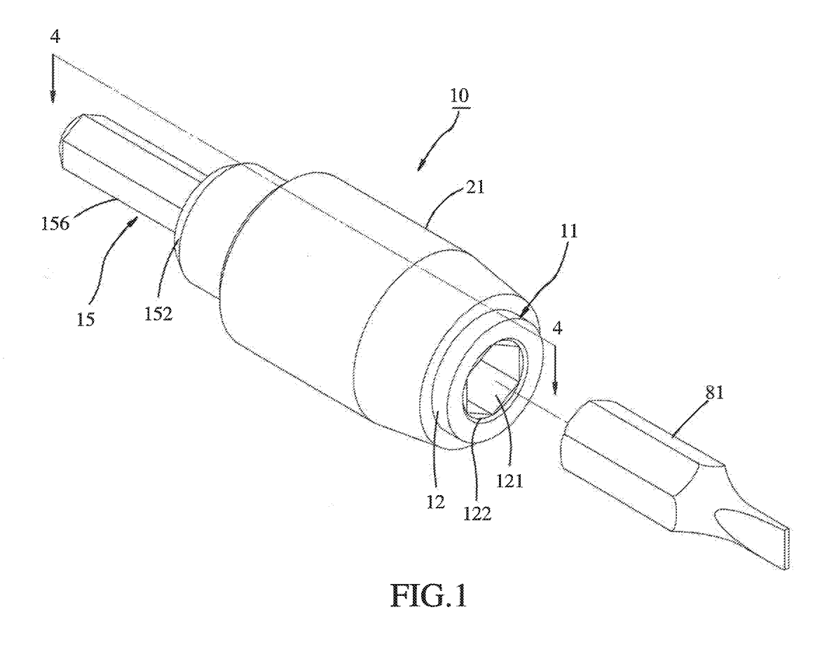

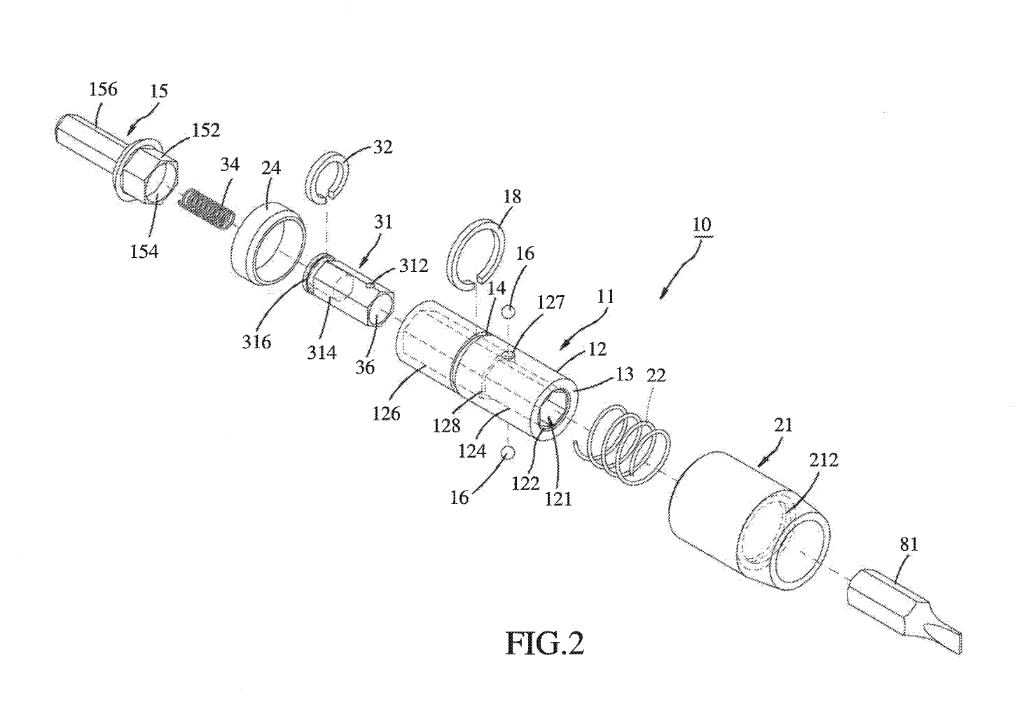

Referring to FIGS. 1-4, a tool bit adapter 10 for use in a hand tool to detachably secure a tool bit 81 in accordance with a first embodiment of the present invention is shown. The tool bit adapter 10 comprises a base member 11, an operating member 21, a pusher 31, and a locating member 36.

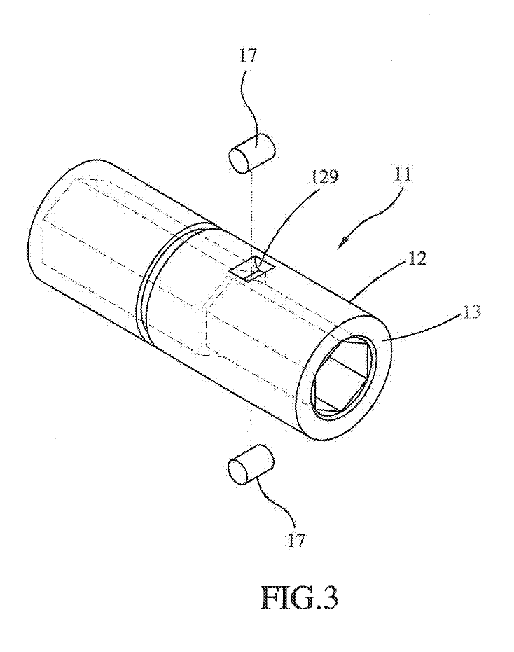

The base member 11 comprises a cylindrical body 12, a receiving open chamber 121 longitudinally defined in the cylindrical body 12, an orifice 122 located in a front end of the cylindrical body 12 in communication with the receiving open chamber 121, a small diameter portion 124 formed of a front part of the receiving open chamber 121 for receiving a tool bit 81 that is inserted into the orifice 122, a large diameter portion 126 formed of a rear part of the receiving open chamber 121, a shoulder 128 formed in the receiving open chamber 121 between the small diameter portion 124 and the large diameter portion 126, at least one through hole 127 transversely cut through the peripheral wall of the cylindrical body 12 in communication with the small diameter portion 124, a first annular groove 14 extending around the outer perimeter of the cylindrical body 12 within the area corresponding to the large diameter portion 126, a ball 16 received in each through hole 127, and a first retaining ring 18 fastened to the first annular groove 14 around the cylindrical body 12. In this first embodiment, the base member 11 consists of a tube member 13 and a mounting bar 15. The mounting bar 15 comprises an engaging portion 152 located at a front end thereof and engaged into a rear end of the tube member 13, a second accommodation chamber 154 defined in the engagement portion 152, and a handle 156 connected to a rear end of the engaging portion 152. The cylindrical body 12 is formed of the tube member 13 and the engaging portion 152 of the mounting bar 15. However, the cylindrical body 12 can be formed integrally with the base member 11. Further, the number of the at least one through hole 127 and the number of the at least one ball 16 in this embodiment are plural. In this first embodiment, each of the at least one through hole 127 is a circular hole fitting the respective ball 16. However, as shown in FIG. 3, at least one elongated through hole 129 and at least one needle roller 17 can be employed to substitute for the at least one through hole 127 and the at least one ball 16.

The operating member 21 is a hollow member, comprising an inside groove 212 made in an annular shape and extending around an inside wall thereof a pressure face 214 made in an annular shape and protruded from and extending around the inside wall, and an inside shoulder 216 located on the inside wall. Further, first elastic member 22 is sleeved onto the cylindrical body 12 and stopped between the retaining ring 18 and the operating member 21 for imparting an elastic potential energy to the operating member 21 in a predetermined direction. Further, a locating ring 24 is in a rear end of the operating member 21 and abutted against the inside wall of the operating member 21. In this first embodiment, the pressure face 214 is disposed at a rear side relative to the inside groove 212. The locating ring 24 is adapted for stopping against the retaining ring 18 to limit the forward displacement of the operating member 21. The first elastic member 22 is disposed at a front side relative to the retaining ring 18, and stopped between the retaining ring 18 and the inside shoulder 216 of the operating member 21 to impart a forward pressure to the operating member 21.

The pusher 31 is received in the receiving open chamber 121 of the cylindrical body 12 and slidable relative to the cylindrical body 12 between a front end position Pf and a rear end position Pr, comprising at least one recessed retaining portion 312 located in the periphery thereof, and a second annular groove 316 extending around the periphery near a rear end thereof. Further, a second retaining ring 32 is fastened to the second annular groove 316 and stopped against the shoulder 128 of the cylindrical body 12. Further, a second elastic member 34 has its one end stopped against the pusher 31, and its other end stopped against the bottom wall of the receiving open chamber 121 of the cylindrical body 12. Thus, the second elastic member 34 is capable of providing an elastic potential energy to the pusher 31. In this first embodiment, the number of the at least one recessed retaining portion 312 is plural and respectively made in the form of a retaining groove 312. These recessed retaining portions (retaining grooves) 312 are equiangularly formed in the periphery of the pusher 31 near a front end thereof. The pusher 31 further comprises a first accommodation chamber 314 formed in the rear end. The second elastic member 34 has its one end accommodated in the first accommodation chamber 314. Further, the second accommodation chamber 154 of the mounting bar 15 is adapted for accommodating an opposite end of the second elastic member 34.

The locating member 36 is adapted to detachably secure the tool bit 81 in the small diameter portion 124 of the receiving open chamber 121 of the cylindrical body 12. In this first embodiment, the locating member 36 is a magnet mounted in the front end of the pusher 31.

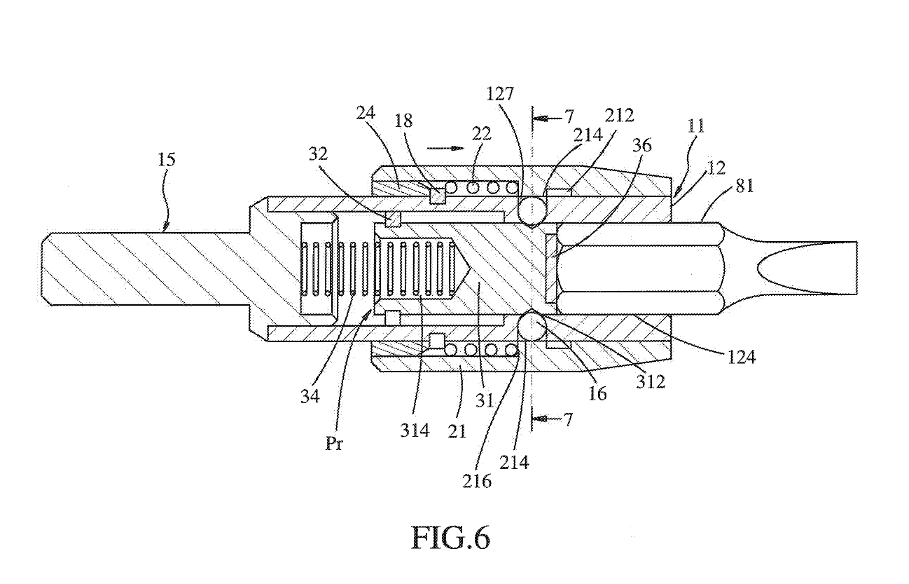

Further, when the pusher 31 is in the rear end position Pr, the pressure face 214 of the operating member 21 is stopped against the balls 16, as shown in FIG. 6, forcing the balls 16 toward the inside of the receiving open chamber 121 of the cylindrical body 12 into engagement with the respective retaining grooves 312 of the pusher 31.

After understanding the structural features of the first embodiment of the present invention, the operation of this first embodiment is outlined hereinafter.

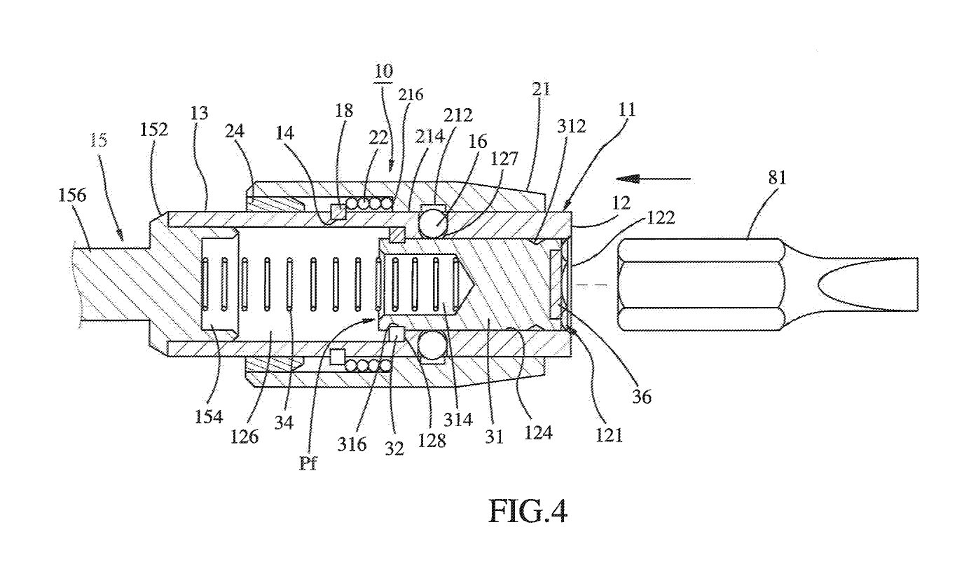

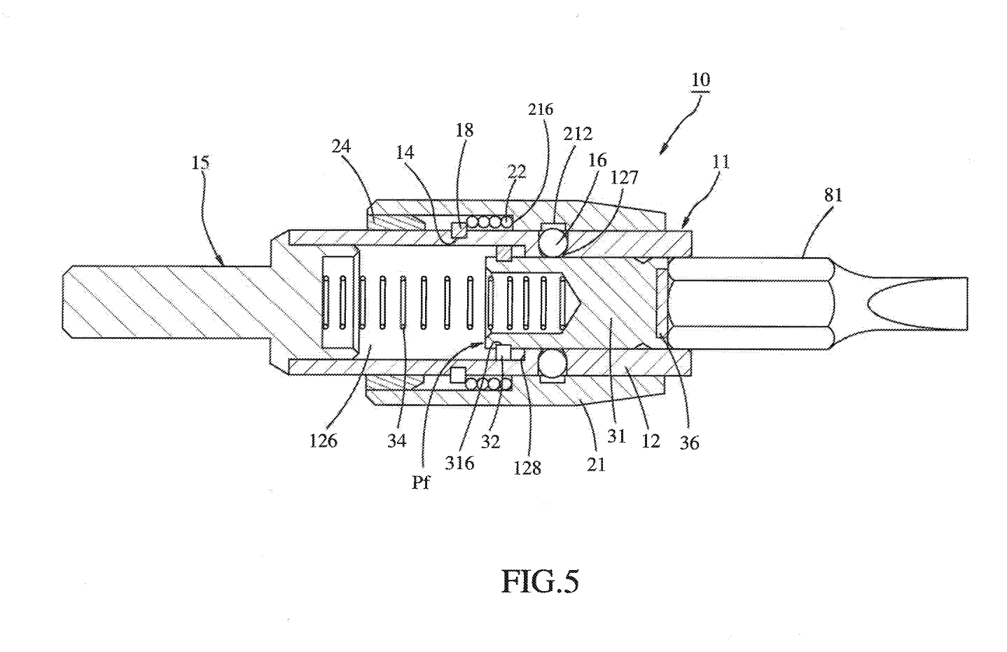

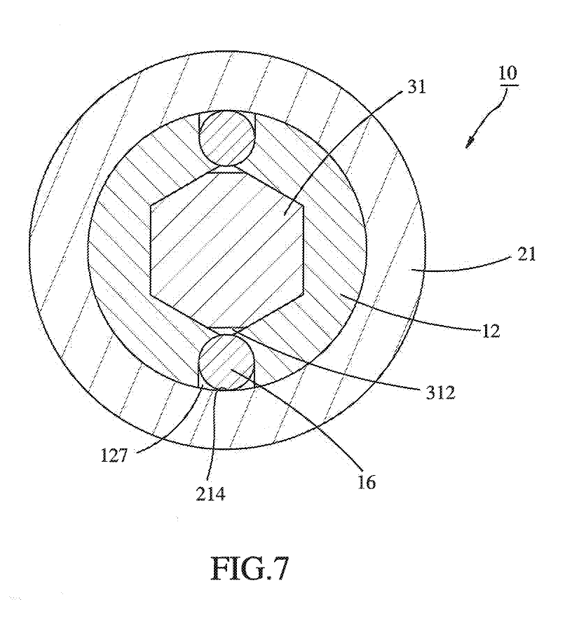

Referring to FIG. 4 at first, when fastening a tool bit Si to the tool bit adapter 10, insert the tool bit 81 through the orifice 122 into the small diameter portion 124 of the cylindrical body 12, as shown in FIG. 5, to push the pusher 31 backwardly away from the front end position Pf toward the rear end position Pr, thereby compressing the second elastic member 34. When reached the rear end position Pr, as shown in FIGS. 6 and 7, the retaining grooves 312 of the pusher 31 are respectively aimed at the balls 16, and the balls 16 are respectively disengaged from the inside groove 212 of the operating member 21. At this time, the inside shoulder 216 of the operating member 21 is forced forwards by the first elastic member 22 to the position where the locating ring 24 is stopped against the retaining ring 18. At the same time, the pressure face 214 of the operating member 21 pushes the balls 16 toward the inside of the receiving open chamber 121 into engagement with the respective retaining grooves 312 of the pusher 31. At this time, the tool bit 81 is positioned in the small diameter portion 124, and the magnet 36 of the pusher 31 secures the tool bit 81 in position by magnetic attraction.

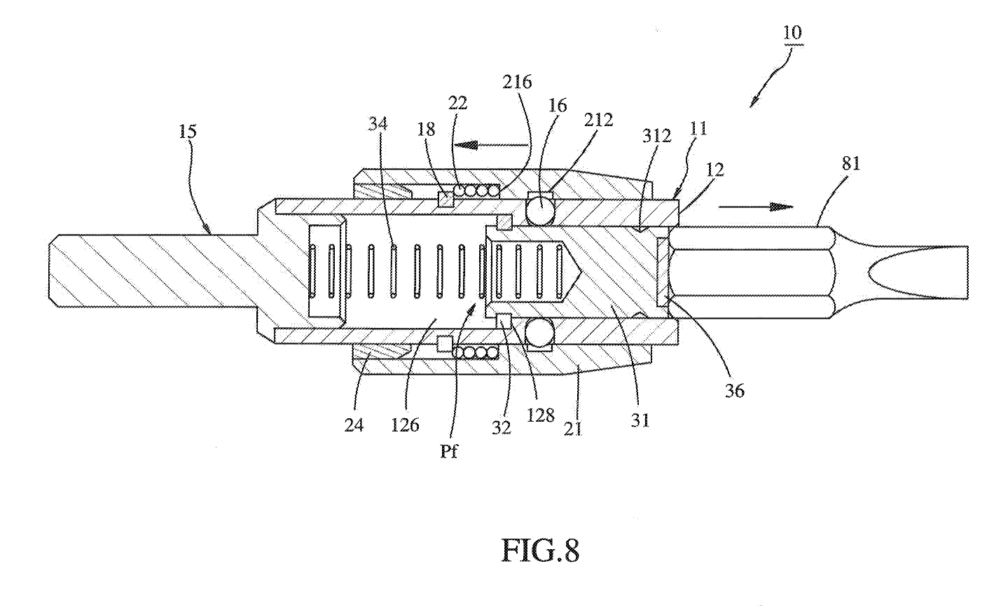

Referring to FIG. 6, when wishing to detach the tool bit 81 from the tool bit adapter 10, pull the operating member 21 backwards to force the inside shoulder 216 of the operating member 21 against the first elastic member 22 till that the inside groove 212 of the operating member 21 is kept in alignment with the balls 16. At this time, the balls 16 are disengaged from the retaining grooves 312 of the pusher 31, allowing the pusher 31 to be pushed forwards by the second elastic member 34 from the rear end position Pr to the front end position Pf, as shown in FIG. 8. At this time, the second retaining ring 32 of the pusher 31 is stopped against the shoulder 128 of the base member 11 to prohibit the pusher 31 from further forward displacement. At the same time, the pusher 31 forces the balls 16 toward the outside of the receiving open chamber 121 into engagement with the inside groove 212 of the operating member 21. At this time, the tool bit 81 is pushed out of the small diameter portion 124 of the cylindrical body 12, and thus, the user can remove the tool bit 81 from the magnet 36 of the pusher 31.

Thus, when mounting a tool bit 81 in the tool bit adapter 10 in accordance with the first embodiment of the present invention, insert the tool bit 81 into the receiving open chamber 121 of the cylindrical body 12 to push the pusher 31 from the front end position Pf to the rear end position Pr, enabling the balls 16 to engage the respective retaining grooves 312 of the pusher 31 and the magnet 36 of the pusher 31 to attract the tool bit 81; when dismounting the tool bit 81, pull the operating member 21 backwards to move the pusher 31 from the rear end position Pr to the front end position Pf, enabling the balls 16 to be positioned in the inside groove 212 of the operating member 21, and the user can then remove the tool bit 81 from the magnet 36 of the pusher 31. Thus, the tool bit adapter 10 of the first embodiment of the present invention facilitates mounting and dismounting of a tool bit 81 without any additional positioning structure.

In the aforesaid first embodiment, the number of the at least one through hole 127, the number of the at least one ball 16 and the number of the at least one retaining groove 312 are plural. However, the first embodiment can also be configured having only one single through hole 127, one single ball 16 and one single retaining groove 312. In this case, when loading the tool bit 81, the pusher 31 must be moved to the position there the retaining groove 312 is aimed at the ball 16 so that the ball 16 can be forced into engagement with the retaining groove 312 to lock the pusher 31.

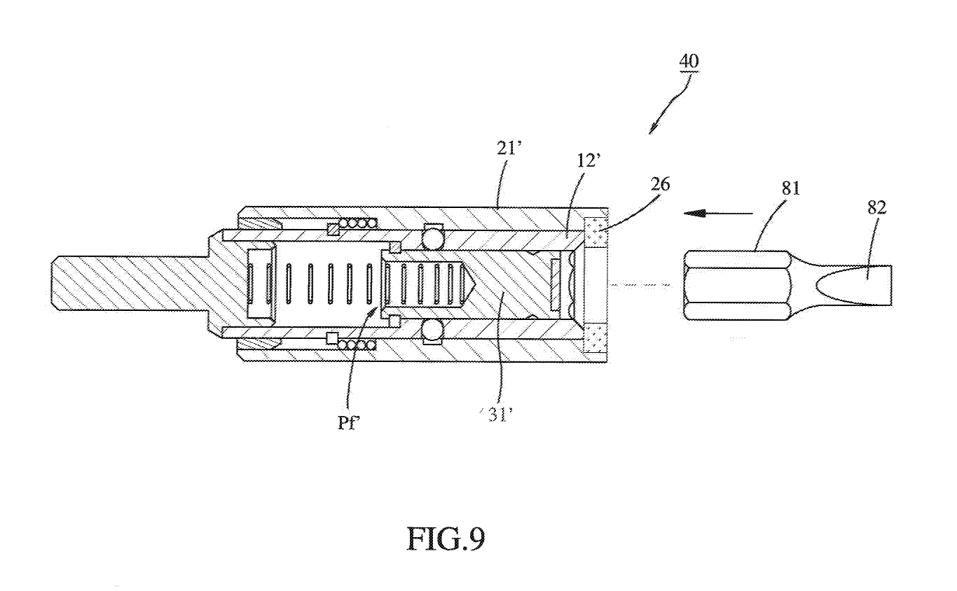

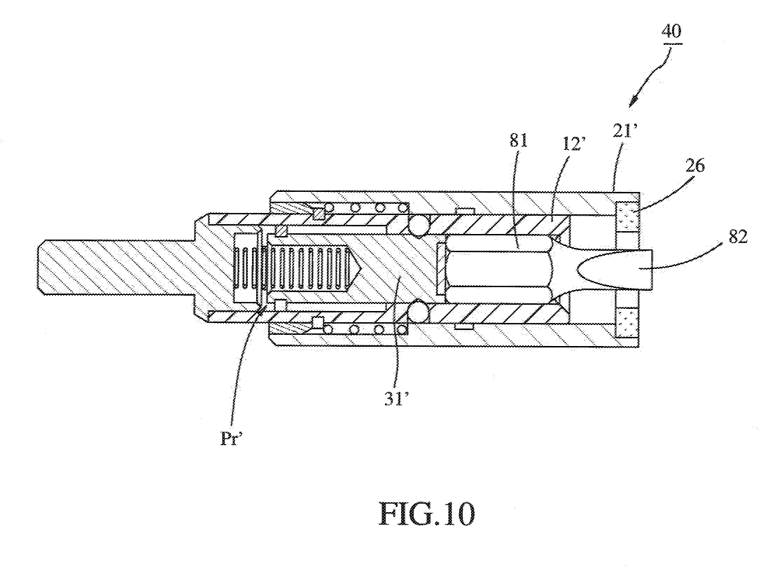

Referring to FIGS. 9 and 10, a tool bit adapter 40 in accordance with a second embodiment of the present invention. This second embodiment is substantially similar to the aforesaid first embodiment with the exceptions as described below:

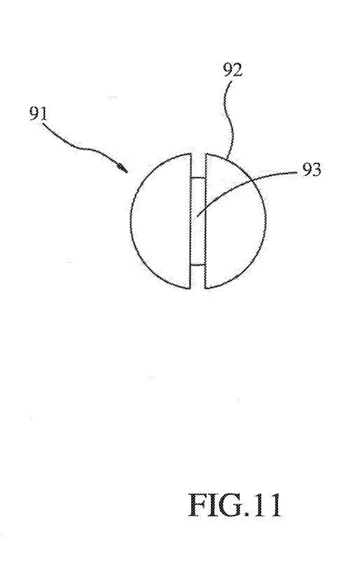

The operating member 21′ comprises a magnetic ring 26 mounted in the front end of thereof. When the pusher 31′ is in the rear end position Pr′, the magnetic ring 26 does not pass over the front end of the driving tip 82 of the tool bit 81. Further, as illustrated in FIGS. 10 and 11, when the pusher 31′ is in the rear end position Pr′, the distance d1 between the front end of the magnetic ring 26 of the operating member 21′ and the front end of the driving tip 82 of the tool bit 81 is not larger than the depth d2 of the slot 92 of a mating screw 91 drivable by the tool bit 81. Further, the distance d3 between the front end of the driving tip 82 of the tool bit 81 and the bottom wall of the slot 93 in the head 92 of a mating screw 91 drivable by the tool hit 81 is smaller than the distance d4 between the center of each ball 16′ and the center of the inside groove 212′ of the operating member 21′.

After understanding the structural features of the second embodiment of the present invention, the operation of this second embodiment is outlined hereinafter.

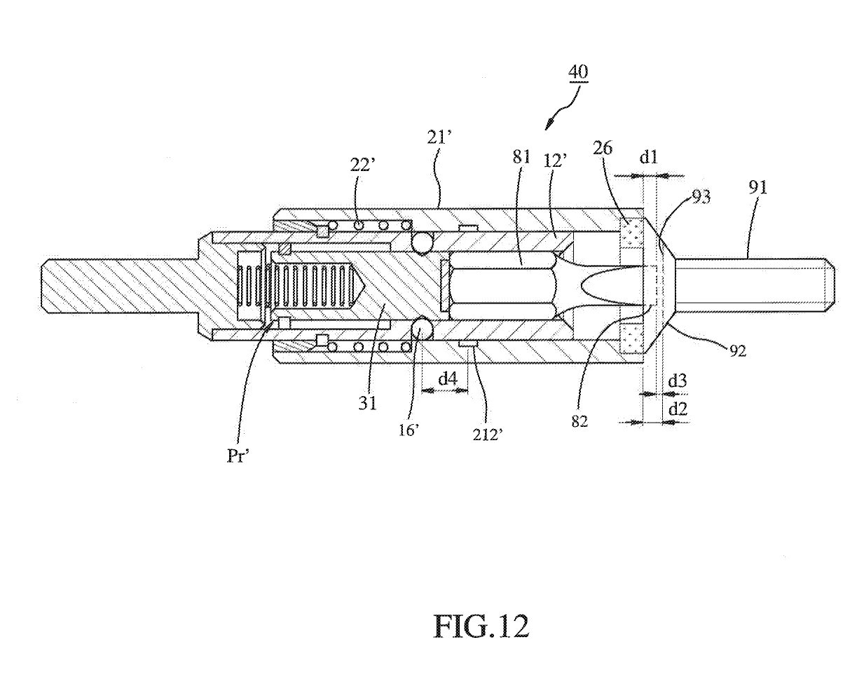

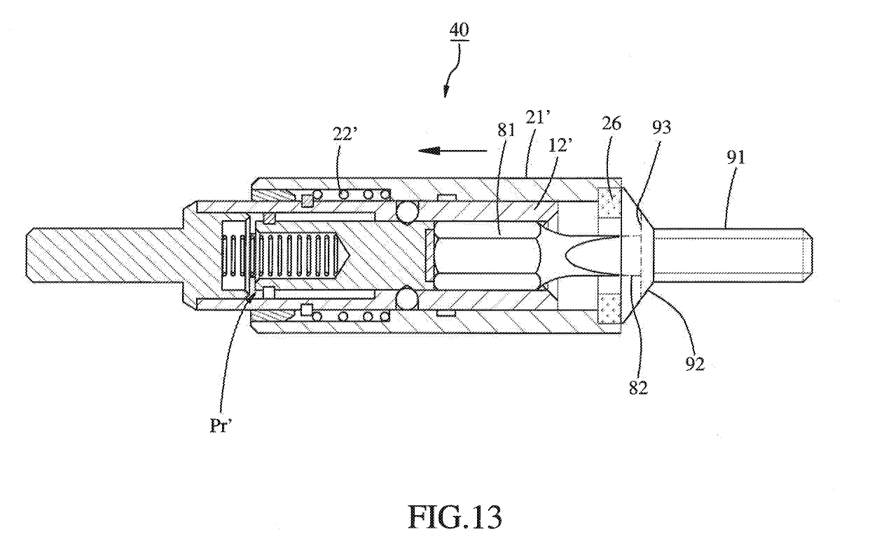

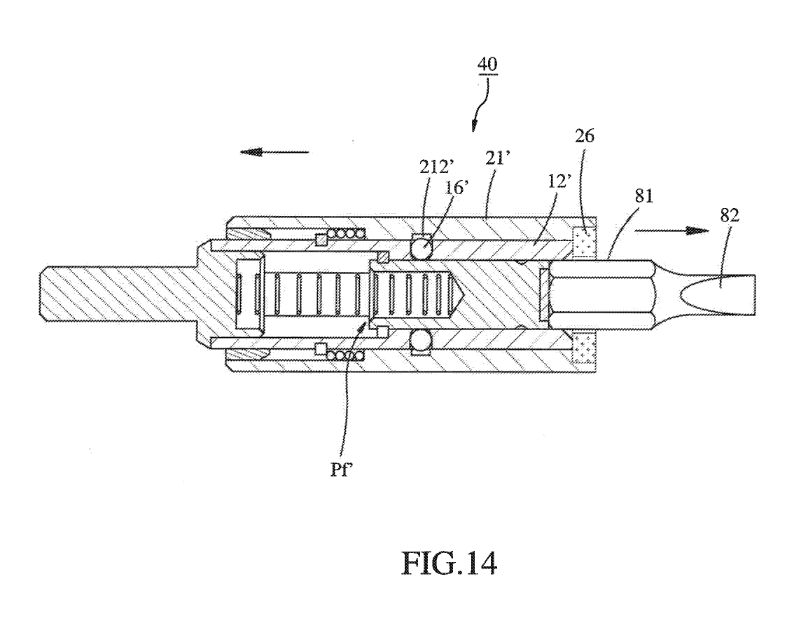

Referring to FIG. 9 at first, when fastening a tool bit 81 to the tool bit adapter 40, insert the tool bit 81 into the cylindrical body 12, as shown in FIG. 9, enabling the tool bit 81 to be secured to the cylindrical body 12′ and the pusher 31′ in the same manner as the aforesaid first embodiment. When operating the tool bit adapter 40 to fasten up the screw 91, attach the magnetic ring 26 of the operating member 21′ to the head 92 of the screw 91 to engage the driving tip 82 of the tool bit 81 into the slot 93 in the head 92 of the screw 91, as shown in FIGS. 11 and 12. At this time, the distance between the front end of the driving tip 82 of the tool bit 81 and the bottom wall of the slot 93 in the head 92 of the screw 91 is the distance d3. Thereafter, push the tool bit adapter 40 forward. Because the magnetic ring 26 of the operating member 21′ is stopped against the head 92 of the screw 91, the operating member 21′ is forced backwards to compress the first elastic member 22′ at this time, and therefore the driving tip 82 of the tool bit 81 completely fits the slot 93 in the head 92 of the screw 91, as shown in FIG. 13. Thereafter, rotate the tool bit adapter 40, driving the driving tip 82 of the tool bit 81 to fasten up the screw 91. On the contrary, when wishing to unfasten the screw 91, rotate the tool bit adapter 40 in the reversed direction, driving the driving tip 82 of the tool bit 81 to loosen the screw 91. As this time, the operating member 21′ is pushed forward by the first elastic member 22′, as shown in FIG. 12, and the head 92 of the unfastened screw 91 is attracted to the magnetic ring 26 of the operating member 21′, and thus the user can remove the screw 91 from the magnetic ring 26. Referring to FIG. 10, the procedure of dismounting the tool bit 81 from the tool hit adapter 40 is same as the aforesaid first embodiment, as shown in FIG. 14.

Further, the magnetic ring 26 is mounted in the operating member 21′ for attracting the screw 91 during application.

The other part of the structure of this second embodiment and its effects are same as the aforesaid first embodiment, and therefore, no further detailed description in this regard is necessary.

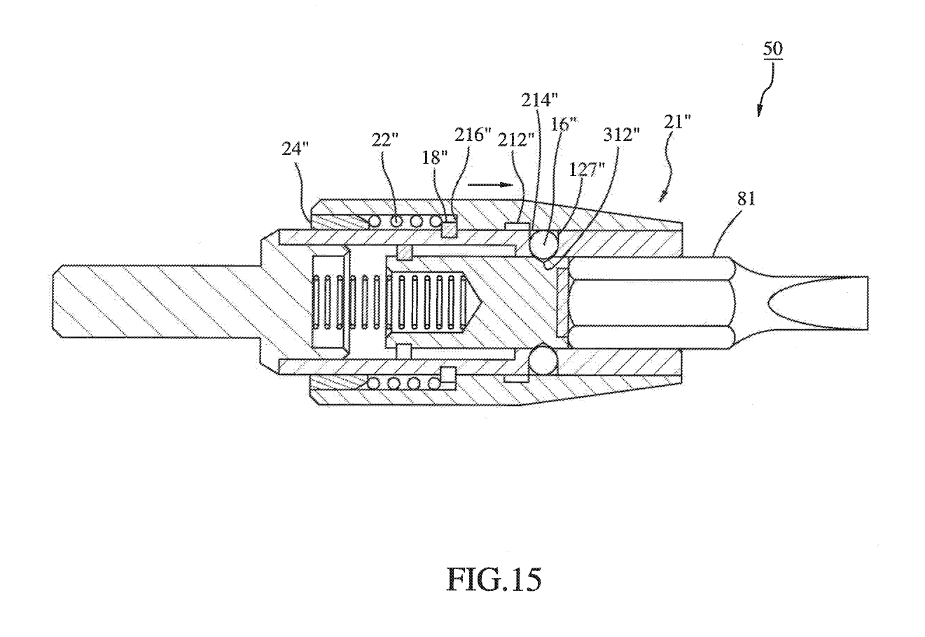

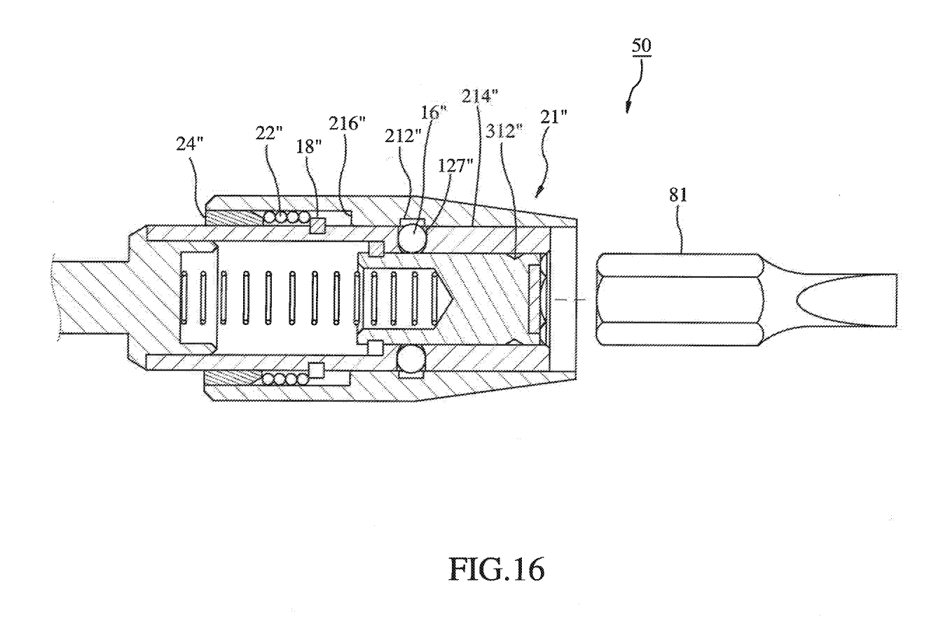

Referring to FIGS. 15 and 16, a tool bit adapter 50 in accordance with a third embodiment of the present invention is shown. This third embodiment is substantially similar to the aforesaid first embodiment with the exceptions as described below:

The pressure face 214″ is disposed at a front side relative to the inside groove 212″; the operating member 21″ has an inside shoulder 216″ located on the inside wall thereof.

The first elastic member 22″ is disposed at a sear side relative to the retaining ring 18″ and stopped between the retaining ring 18″ and the locating ring 24″, and adapted to provide a backward pressure to the operating member 21″.

The inside shoulder 216″ is configured for stopping against the retaining ring 18″ to limit the backward displacement of the operating member 21″.

When using this third embodiment, the operating direction of the operating member 21″ is reversed to the aforesaid first embodiment, i.e., the operating member 21″ is pushed forward after insertion or dismounting of the tool bit 81, moving the inside groove 212″ into alignment with the through holes 127″ to disengage the balls 16″ from the retaining grooves 312″.

The other part of the structure of this third embodiment and its effects are same as the aforesaid first embodiment, and therefore, no further detailed description in this regard is necessary.

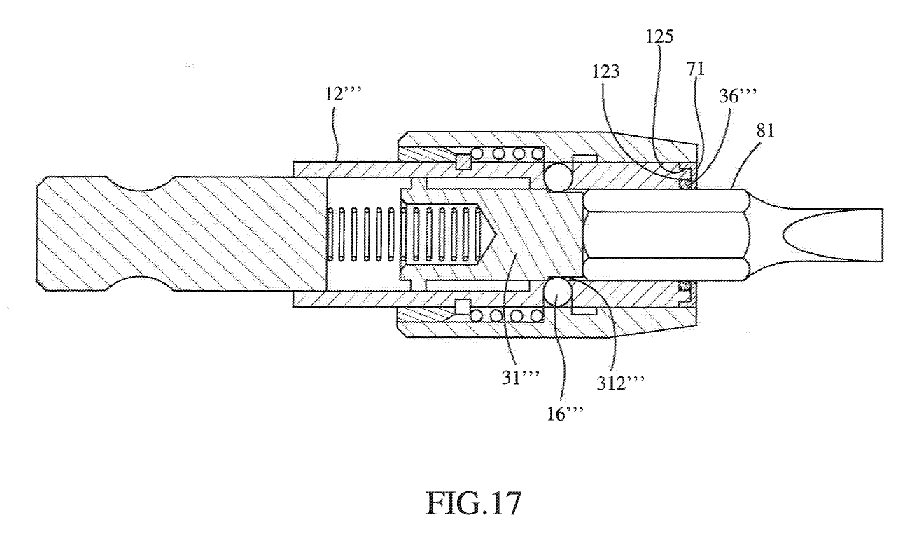

Referring to FIG. 17, a tool bit adapter 60 in accordance with a fourth embodiment of the present invention is shown. This fourth embodiment is substantially similar to the aforesaid first embodiment with the exceptions as described below:

The aforesaid first embodiment secures the loaded tool bit 81 by magnetic attraction. This third embodiment uses an elastic force to hold down the loaded tool bit 81.

This third embodiment further comprises an end cap 71.

The locating member 36′″ in this third embodiment is an elastic ring 36′″.

The cylindrical body 12′″ has an inside groove 123 located in the front end thereof, an outer groove 125 located in the periphery. The elastic ring 36′″ is mounted in the inside groove 123. The end cap 71 is press-fitted onto the outer groove 125 to hold down the elastic ring 36′″.

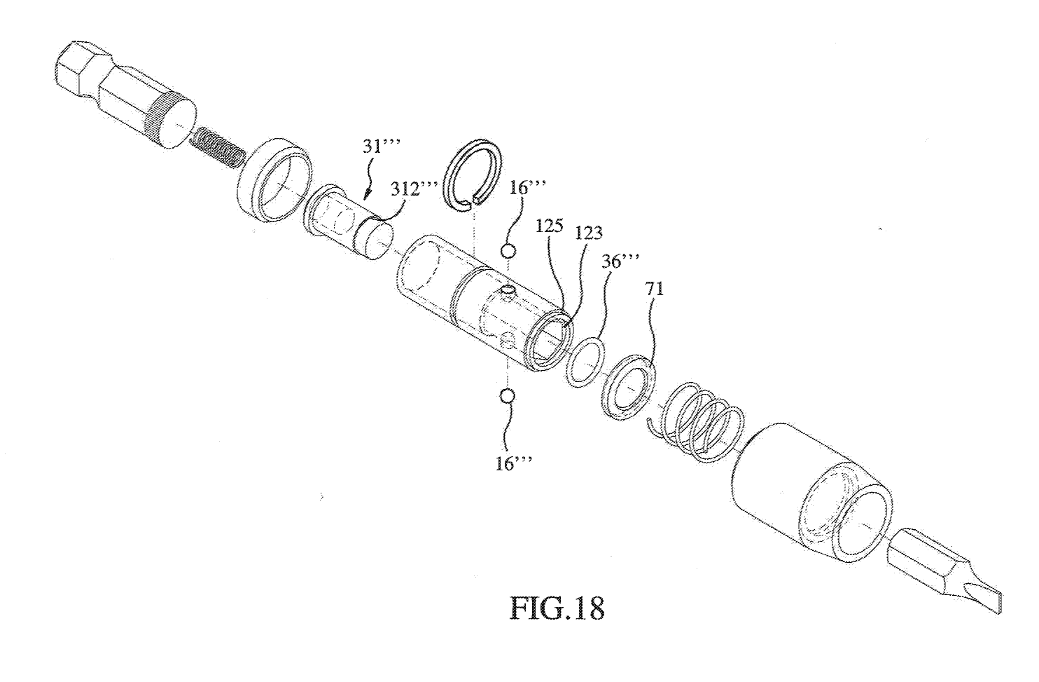

In the above-described first through third embodiments of the present invention, the pusher 31 or 31′ has a hexagonal cross section; in the above-described fourth embodiment, the pusher 31′″ has a cylindrical shape, as shown in FIG. 18.

Further, the pusher 31′″ has at least one recessed retaining portion 312′″. The at least one recessed retaining portion 312′″ is formed on the periphery of the front part of the pusher 31′″ by milling.

After insertion of a tool bit 81 into the tool bit adapter 60 during the operation of the fourth embodiment of the present invention, the balls 16′″ are engaged into the inside groove 312′″, and the elastic ring 36′″ is elastically abutted against the tool bit 81 to secure the tool hit 81 in position.

Thus, unlike the method of securing the loaded tool bit 81 by magnetic attraction, the elastic ring 36′″ uses an elastic force to hold down the loaded tool hit 81.

The other part of the structure of this fourth embodiment and its effects are same as the aforesaid first embodiment, and therefore, no further detailed description in this regard is necessary.

Although particular embodiments of the invention have been described in detail for purposes of illustration, various modifications and enhancements may be made without departing from the spirit and scope of the invention. Accordingly, the invention is not to be limited except as by the appended claims.

1. A tool bit adapter, comprising:
a base member comprising a cylindrical body, said cylindrical body comprising a receiving open chamber defined therein, an orifice located in a front end thereof in communication with said receiving open chamber, an internal small diameter portion formed of a front part of said receiving open chamber for receiving a tool bit that is inserted through said orifice, an internal large diameter portion formed of a rear part of said receiving open chamber, an internal shoulder connected between said small diameter portion and said large diameter portion, at least one through hole cut through said cylindrical body in communication between said small diameter portion and the atmosphere, a first annular groove extending around the periphery of said cylindrical body near a rear end thereof, at least one ball respectively accommodated in said at least one through hole, and a retaining ring mounted in said first annular groove of said cylindrical body;
an operating member comprising an inside groove made in an annular shape and extending around an inside wall thereof, a pressure face made in an annular shape and extending around the inside wall thereof, a first elastic member mounted around the periphery thereof and stopped between said retaining ring and said operating member to impart an elastic force to said operating member in a predetermined direction, and a locating ring mounted in a rear end thereof;
a pusher received in said receiving open chamber of said cylindrical body and slidable relative to said cylindrical body between a front end position and a rear end position, said pusher comprising at least one recessed retaining portion located in the periphery thereof, a second annular groove extending around the periphery near a rear end thereof, a second retaining ring fastened to said second annular groove and stopped against said shoulder of said cylindrical body, and a second elastic member stopped between said pusher and a bottom wall of said receiving open chamber of said cylindrical body to impart an elastic force to said pusher;
a locating member for detachably securing an inserted tool bit in said small diameter portion of said receiving open chamber; and
wherein when said pusher is in said rear end position, said at least one ball is forced by said pressure face of said operating member toward the inside of said receiving open chamber into engagement with said at least one recessed retaining portion.

2. The tool bit adapter as claimed in claim 1, wherein said pressure face is disposed at a rear side relative to said inside groove; said locating ring is adapted for stopping said retaining ring to limit the forward displacement of said operating member; said operating member further comprises an inside shoulder; said first elastic member is disposed at a front side relative to said retaining ring and stopped between said retaining ring and the inside shoulder of said operating member to impart a forward elastic force to said operating member.

3. The tool bit adapter as claimed in claim 1, wherein said pressure face is disposed at a front side relative to said inside groove; said operating member comprises an inside shoulder; said first elastic member is disposed at a rear side relative to said retaining ring and stopped between said retaining ring and said locating ring to impart a backward elastic force to said operating member; the inside shoulder of said operating member is adapted for stopping said retaining ring to limit the backward displacement of said operating member.

4. The tool bit adapter as claimed in claim 1, wherein said locating member is a magnet mounted in the front end of said pusher.

5. The tool bit adapter as claimed in claim 1, further comprising an end cap,
wherein said locating member is an elastic ring; said cylindrical body comprises an inside groove located in the front end thereof, an outer groove located in the periphery thereof; said elastic ring is mounted in said inside groove; said end cap is fastened to said outer groove to hold down said elastic ring.

6. The tool bit adapter as claimed in claim 1, wherein said at least one recessed retaining portion of said pusher is located in the periphery of a front part thereof.

7. The tool bit adapter as claimed in claim 1, wherein said pusher further comprises a first accommodation chamber formed in the rear end thereof; said second elastic member has one end thereof accommodated in said first accommodation chamber.

8. The tool bit adapter as claimed in claim 1, wherein said base member consists of a tube member and a mounting bar, said mounting bar comprising an engaging portion located at a front side thereof and connected to a rear end of said tube member, a second accommodation chamber located in said engaging portion for accommodating an opposite end of said second elastic member and a handle extended from a rear side of said engaging portion; said cylindrical body is formed of said tube member and said engaging portion of said mounting bar.

9. The tool bit adapter as claimed in claim 1, wherein said operating member further comprises a magnetic ring mounted in a front end of said operating member; when said pusher is in said rear end position, said magnetic ring is disposed at a rear side relative to a front tip of the loaded tool bit.

10. The tool bit adapter as claimed in claim 9, wherein the distance between the front end of said magnetic ring of said operating member and the front tip of the loaded tool bit is not greater than the depth of the slot of a mating screw drivable by said tool bit.

11. The tool bit adapter as claimed in claim 10, wherein the distance between the front tip of the loaded tool bit and the bottom wall of the slot in the head of a mating screw drivable by said tool bit is smaller than the distance between the center of each said ball and the center of said inside groove of said operating member.
